(19) United States
(12) Patent Application Publication
(10) Pub. No.: US 2011/0251785 A1
(43) Pub. Date: Oct. 13, 2011

(54) EXCURSION PLANNING DEVICE AND METHOD

(76) Inventor: Josh Koppel, New York, NY (US)

(21) Appl. No.: 13/001,226

(22) PCT Filed: Jun. 29, 2009
(86) PCT No.: PCT/US09/49119

§ 371 Date: Jul. 1, 2011

Related U.S. Application Data
(60) Provisional application No. 61/076,674, filed on Jun. 29, 2008.

(51) Int. Cl. G01C 21/00

(52) U.S. Cl. 701/201

(57) ABSTRACT

Embodiments of the invention provide systems and methods which enable a consumer to rapidly plan an excursion. Embodiments of the invention enable a consumer to indicate a destination for an excursion, and to receive information comprising excursion packages, wherein each package includes excursion components selected by the consumer and related to consumer-provided criteria.

### CROSS REFERENCE TO RELATED APPLICATIONS

This application claims benefit of priority to U.S. provisional application Ser. No. 61/076,674 filed in the USPTO on Jun. 29, 2008 incorporated by reference herein in its entirety.

### FIELD OF THE INVENTION

The present invention relates generally to systems and methods for computing and indicating travel information associated with the distance measured from a present position to a terminating position, and more particularly to methods and systems providing excursion component information for travel excursions where distance between points in an excursion plan is a factor in the plan.

### BACKGROUND OF THE INVENTION

Travelers embark upon a variety of types of journeys. For purposes of this specification one type of journey is an excursion. An excursion is a relatively brief pleasure trip taken on relatively short notice. Another type of journey is a vacation. In contrast to excursions, vacations are typically longer trips, and are often planned months in advance of departure. For ease of discussion, the present specification refers to journeys as comprising components. For purposes of this specification, journey components include, but are not limited to: geographical destination components, transportation components, lodging components, meal components and entertainment components.

Various conventional systems are available to aid a traveler in planning particular components of a vacation. For example, U.S. Pat. No. 6,622,084 to Cardno, et al. is directed to planning transportation components of a journey. According to Cardno, integrated journey [transportation] planners can combine timetabled information (for rail for example) and non-timetabled information (for cars for example) to provide integrated journey [transportation] information. For example, Cardno describes a method of planning a travel route including maintaining in a memory a reference database comprising one or more travel data sets, each travel data set representing a travel option from a travel origin to a travel destination.

Another example of a transportation component planner is found in U.S. Pat. No. 6,834,229 to Moshe, et al. entitled: “Integrated journey planner” issued Dec. 21, 2004. This patent is directed to an integrated journey planner that deconstructs user enquiries [related to transportation components] into information requests, each specifying a journey part using a single transport mode, e.g., rail, car or coach. The planner sends each request to one of a plurality of local and on-line databases, each corresponding to a different transport mode. Responses from the databases are reconstructed into multi-modal travel option(s) for the user specified journey, incorporating different transport modes. Also, a user can specify a geographical location and a transport mode to find the most suitable terminals and services for uni-modal point to point travel. Both Cardno and Moshe are directed to providing information related to transportation components of a journey.

Conventional systems for planning vacation components include U.S. 2002/0091535 to Kendall, et al. Kendall is directed to an interactive vacation destination selection system. Criteria which may be important to a consumer are identified and categorized. The system assesses what a consumer wants in a vacation destination by means of questionnaires. Based on the consumer responses, the system identifies vacation destinations having the attributes that satisfy those wants, and then displays comparative data on those vacation destinations. In that regard, Kendall is directed to destination components of a vacation.

Each of the above systems is useful in advising a traveler about an individual component of his or her planned vacation. However, none of the devices provides information related to a plurality of components of a journey that is planned on short notice. One device may be used to provide information related to a transportation component of a journey, while another may be used to provide a destination component. Travelers who desire to plan a plurality of components of a journey are left to assemble their journeys component by component. There is a need for a journey planning device and method that can provide integrated information about all desired components of a journey without the need to provide information about each component separately.

Further, the nature of vacations, journeys, outings and the like are rapidly evolving. Today's hectic and fast paced lifestyles and long work hours are not conducive to advance planning of outings. Many busy professionals have experienced the frustration of having to cancel outings planned weeks or months in advance at the last minute due to unforeseen circumstances. This has led many to avoid or abandon the practice of planning outings in advance.

Instead, excursions, that is, last minute getaways are becoming more popular. Excursions tend to be planned quickly, for example within days, or even hours or minutes of departure. Unlike a vacation, an excursion might provide a needed recreational break, for example, during an unplanned break in a project or work routine. Such an opportunity might arise quickly and unexpectedly and is best acted upon quickly. For such consumers, responding to extensive questionnaires relating to the consumer's overall desires and states of mind adds complexity and time to the planning process. Therefore there exists a need for a planning device which enables a consumer to rapidly devise an excursion on short notice. Further there remains a need for a consumer to indicate a destination for an excursion, and to receive information for a plurality of excursion components related to the selected destination. Further, a need exists for devices and methods which enable a consumer to rapidly select one excursion from a plurality of excursions meeting the consumer's excursion criteria, without the need for the consumer to examine the details of each of the plurality of excursions.

### SUMMARY OF THE INVENTION

Embodiments of the invention provide systems and methods which enable a consumer to rapidly plan an excursion. Embodiments of the invention enable a consumer to indicate a destination for an excursion, and to receive information comprising excursion packages, wherein each package includes excursion components selected by the consumer and related to a consumer-selected destination.

### DESCRIPTION OF THE DRAWING FIGURES

These and other objects, features and advantages of the invention will be apparent from a consideration of the following detailed description of the invention considered in conjunction with the drawing figures, in which:

FIG. 1 is a block diagram of an excursion planning device according to an embodiment of the invention;

FIG. 2 is a flowchart illustrating steps of an automated method for planning an excursion according to an embodiment of the invention;

FIG. 3 is a flowchart illustrating steps of an automated method for generating excursion packages according to an embodiment of the invention;

FIG. 4 is a flowchart illustrating steps of an automated method for planning an excursion according to an embodiment of the invention;

FIGS. 5-7 depict graphical user interfaces suitable for implementing embodiments of an excursion planning device of the invention;

FIG. 8 depicts a graphical user interface enabling a user to select a destination according to an embodiment of the invention;

FIG. 9 depicts a graphical user interface enabling a user to select excursion components according to an embodiment of the invention;

FIG. 10 depicts a graphical user interface enabling a user to provide excursion criteria according to an embodiment of the invention;

FIG. 11 depicts a graphical user suitable for displaying excursion packages to a user according to an embodiment of the invention;

FIG. 12 depicts a graphical user interface suitable for displaying information related to a first package according to an embodiment of the invention;

FIG. 13 depicts a graphical user interface suitable for displaying information related to a second package according to an embodiment of the invention;

FIG. 14 illustrates an example data dictionary suitable for use in implementing various embodiments of the invention;

FIG. 15 is a block diagram of an accelerometer device suitable for use in various embodiments of the invention;

FIG. 16 is a pictorial diagram illustrating movement of an excursion planning device according to an embodiment of the invention;

FIG. 17 is a block diagram of a package selector according to an embodiment of the invention;

FIG. 18 is a top plan view of a motion detector integrated circuit device according to an embodiment of the invention;

FIG. 19 is a pictorial diagram illustrating directions of detectable movement directions of an excursion planning device according to an embodiment of the invention.

### DETAILED DESCRIPTION OF THE INVENTION

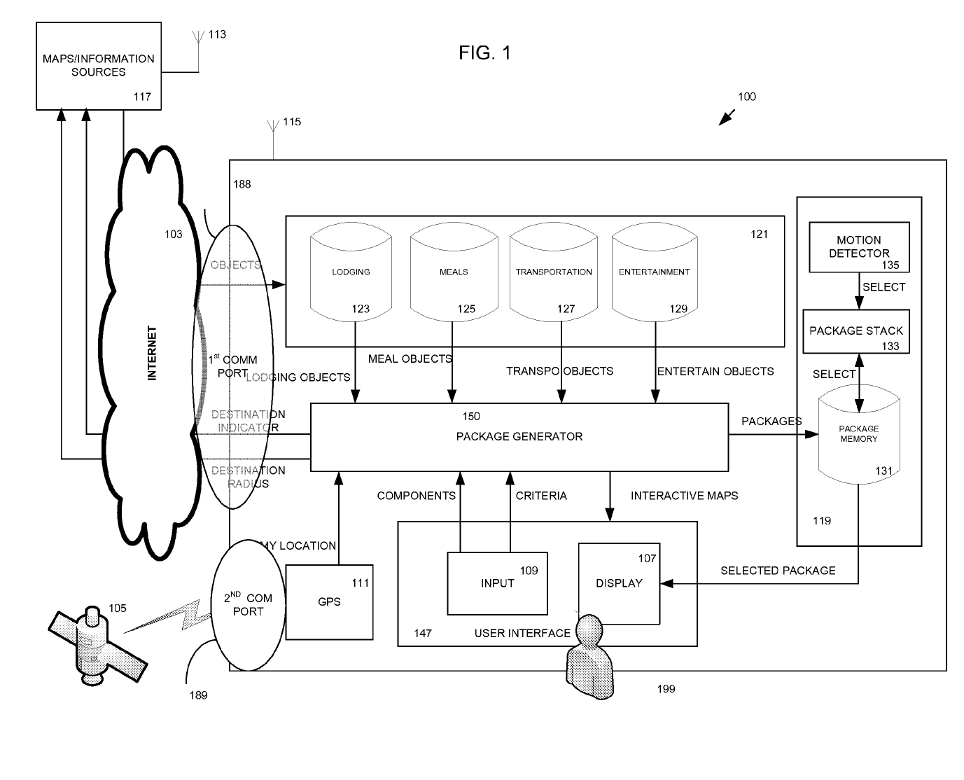

### FIG. 1 System Block Diagram

FIG. 1 is a block diagram of an excursion planning device 100 according to an embodiment of the invention. Device 100 includes at least two communication ports. A first communication port 189 provides an interface by which a positioning system unit, for example, a global positioning system (GPS) unit 111 communicates with an external global positioning system, for example, GPS satellite 105. GPS unit 111 operates to establish a geographical position of device 100. A second communication port 188 provides an interface between device 100 and information sources, for example, maps and geographical information source 117, and the World Wide Web, or “Internet”.

### User Interface Unit

A user interface unit 147 includes a user input device 109 and an information display device 107. Examples of suitable user interface devices include keyboards, keypads, touch screens, trackballs, buttons, switches and other devices enabling a user to provide information to device 100. Examples of suitable display devices include Liquid Crystal Displays (LCDs) such as those commonly found on cellular telephones, personal digital assistants, iPods™, iPhones™ and similar devices.

### Package Generator

A package generator 119 is configured for communication with user interface 147 so as to receive information related to an excursion as provided by a user 199 of device 100. Examples of information received from user 199 include excursion package component information and excursion package criteria information. Package generator 119 searches and retrieves information related to user-specified excursion package components and user provided criteria. Package generator 119 provides at least one excursion package based on the criteria and the retrieved information. The at least one excursion package information is stored in a package memory 131.

### Storage Unit

A storage unit 121 includes databases 123, 125, 127 and 129. Databases 123, 125, 127 and 129 store information received from information sources 117 via 2^{nd} communication port 188. Databases 123, 125, 127 and 129 provide information stored therein to package generator 119. Package generator 119 generates excursion packages based, at least in part on information received from databases 123, 125, 127 and 129 and based, at least in part, on criteria provided by user 199. Package generator 119 is configured to provide the generated packages to a package memory unit 131.

Unit 100 further comprises an accelerometer 135 coupled to a random number generator 133. Accelerometer 135 provides a start signal to random number generator 133 in response to sensing motion of device 100. In response to receiving the start signal, random number generator 131 randomly selects one of the packages stored in package memory 131. The randomly selected package is provide to display 107 of user interface 147 where the package information is displayed for viewing by user 199.

### 1^{st} Communications Port—Internet Port

3G technology gives iPhone fast access to the Internet and email over cellular networks around the world. With support for 7.2 Mbps HSDPA, iPhone 3GS also makes it possible to do more in more places: Surf the web, download email, get directions, and watch video—even while you're on a call. Since iPhone seamlessly switches between EDGE, faster 3G, and even faster Wi-Fi, you always get the fastest connection available. You can even share your Internet connection with your laptop via Internet tethering. Map search tools, such as yp.yahoo.com, mapquest.com, and maps.google.com, allow searching for entities (e.g., businesses such as “sandwich shops”) “near” a known point (e.g., an address or a zip code). The present invention searches an information retrieval system for items of interest that are in proximity to geographical locations identified by the user. In a first embodiment, the information retrieval system performs a search for specified types of businesses or items of interest that surround or are in close proximity to the user's present geographical location. The system receives geographical location information concerning the user's position from the wireless network carrier, which tracks the location of the user's mobile communications device. In this embodiment, the user's identified location becomes the centroid for a radial search to find components in the same geographical area.

2^{nd} Communications Port—GPS Port

According to some embodiments of the invention, package generator 119 is further configured to receive geographic location information for device 100 from Global Positioning System Unit 111. GPS (Global Positioning System) technology uses information from earth-orbiting satellites to find locations. A-GPS (Assisted GPS) on iPhone 3GS goes a step further, finding the closest satellites to more quickly identify your position. If you're not within a clear line of sight to a GPS satellite, iPhone finds you via Wi-Fi. If you're not in range of a Wi-Fi hotspot, iPhone finds you using cellular towers. The size of a location circle tells you how accurately iPhone is able to calculate that location: The smaller the circle, the more accurate the location. iPhone also offers a built-in digital compass that automatically repositions maps to match the direction you're facing.

Second communication port 188 is configured to communicate with package generator 119 to enable package generator 119 to send requests for information from device 100 to information sources 117, and to receive information from information sources 117 in response to the requests. In one embodiment of the invention, device 300 is an integrated personal digital assistant, and Global Positioning System (GPS) device such as an iPhone™, available from Apple™. Other suitable devices include, so called Blackberry' devices and any cellular telephony device with integrated motion sensing devices.

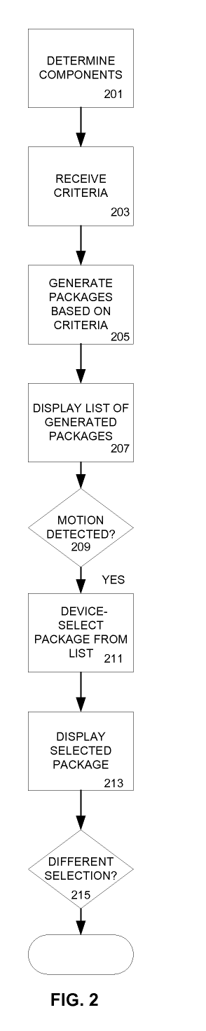

### FIG. 2 System Level Flowchart

FIG. 2 is a flowchart illustrating steps of an automated method for planning an excursion using a device of the type illustrated in FIG. 1 according to an embodiment of the invention.

### Determine Components 201

At 201 components of an excursion are determined. In one embodiment of the invention user 199 operates user interface 147 to select components for an excursion package. FIG. 9 illustrates an example device 900 providing a graphical user interface 911. Graphical user interface 911 is operable by user 199 to select any one of a plurality of components, for example, lodging component 967, meal component 969, entertainment component 971 and transportation component 973. Operation of device 900 for component selection is described in more detail below.

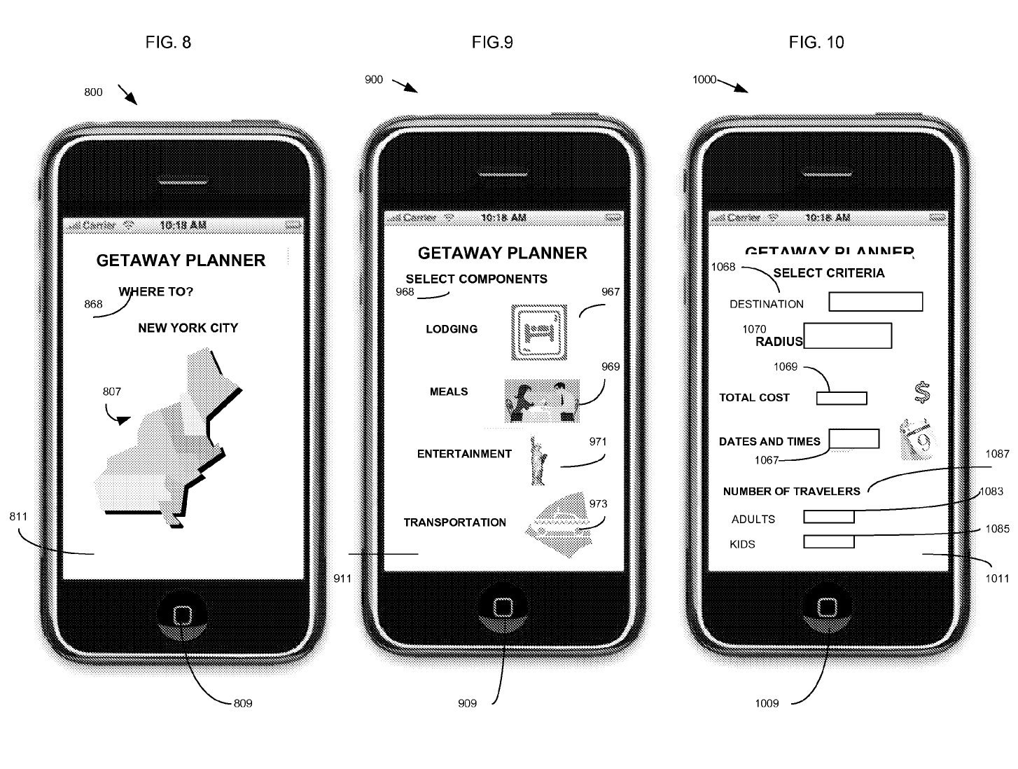

At least one excursion component is selected by user 199. At 203 an excursion component indicator is received by package generator 119 in response to selection of an excursion component by user 199. The excursion component indicator is provided by a user 199 via input unit 109 of user interface 147. Examples of excursion components include: a transportation component; a dining component; a lodging component, and an entertainment component. FIG. 8 illustrates an example of an embodiment of device 100 comprising a user interface enabling user 199 to select excursion components.

As those of ordinary skill in the art will recognize upon reading this specification, other possible embodiments of the invention include other excursion components not illustrated in FIG. 9. For example, other embodiments of the invention contemplate educational components, religious, ethnic and spiritual components and exercise and training components, to name but a few.

### Receive Criteria 203

Returning now to FIG. 2, at 203, excursion criteria are received by device 100. FIG. 10 illustrates an example device 1000 providing a graphical user interface 1011 enabling a user to provide excursion criteria in accordance with method step 203. Example excursion criteria include, but are not limited to, geographic destination 1068, radius from destination (or present location) 1070, total cost of the excursion 1069, dates and times 1067 and number of travelers 1087. For example, one embodiment of the invention enables user 199 to provide criteria related to number of adult travelers 1083 and number of child travelers 1085. Various embodiments of the invention enable a user to select at least one criterion which package generator 150 will use to generate excursion packages. Of course, other embodiments of the invention may enable user 199 to provide more or fewer criteria.

### Generate Packages Based on Criteria 205

Returning now to FIG. 2, at 205 package generator 150 generates at least one excursion package comprising the determined components. Each generated excursion package is based on the criteria provided at 203. According to one embodiment of the invention a plurality of excursion packages are generated by package generator 150. The information for each component of each package generated by package generator 150 is stored in memory.

### Display List of Generated Packages 207

Returning now to FIG. 2 at 207, a list comprising at least a portion of packages generated by package generator 150 is displayed to user 199. In one embodiment of the invention packages comprising user-selected components and meeting user specified criteria is displayed to the user. FIG. 11 illustrates an example graphical user interface including a display 1113. Display 113 displays at least a portion of the packages generated by package generator 150. In the embodiment illustrated in FIG. 11, packages are displayed in list format. However, the invention is not limited to any particular arrangement of displayed packages. In one variation of this embodiment, at least a portion of packages generated by package generator 150 are displayed to user 199, as indicated at 1102, 1101 and 1103 of FIG. 11.

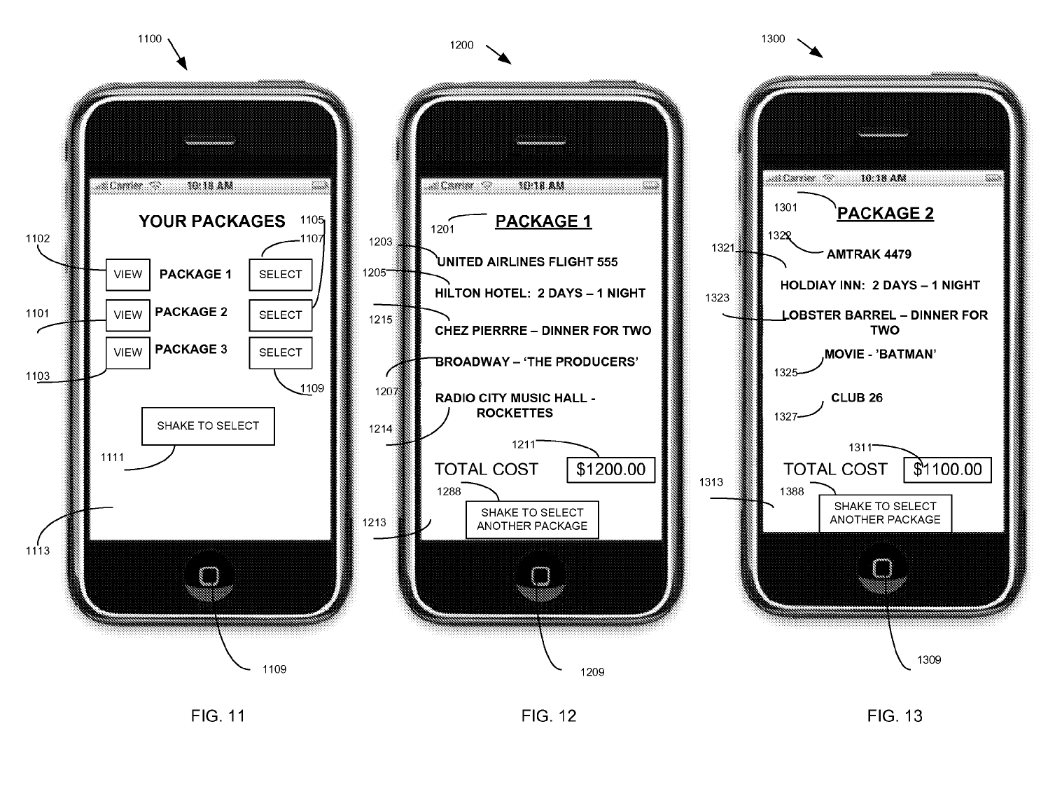

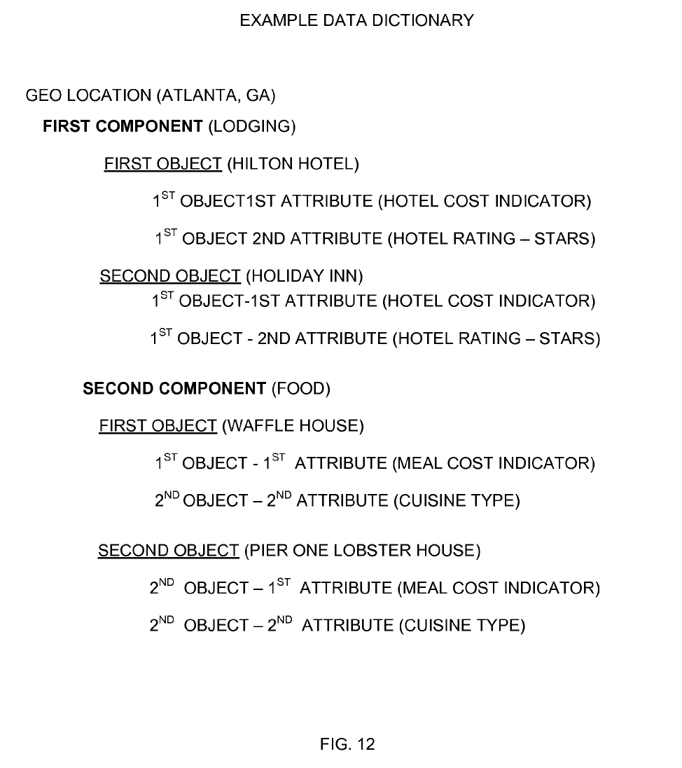

In one embodiment of the invention, interactive icons 1107, 1105 and 1109 enable user 199 to select one of the generated displayed packages. In that case, further information about the selected package is displayed, for example as indicated in FIG. 12 at 1201-1213. According to other embodiments of the invention a package is automatically selected and displayed to user 199 in response to user 199 ‘shaking’ or otherwise moving device 1100.

### Motion Detected

Returning now to FIG. 2, according to one embodiment of the invention a user need not select a package from the list displayed at 207. Instead, device 100 enables user 199 to obtain a device selected package. In that case, device 100 waits for motion of device 100 to be detected at 209, for example, by an accelerometer or other motion sensing device comprising device 100.

### Device-Select 211

In response to device 100 detecting motion, device 100 selects one of the packages generated by package generator 150.

### Display Selected Package

At 207, storage is provided for information relating to each package component indicator received by package generator 119 from user 119 via user interface 147. At 211 excursion plan criteria is received from user 199 via user interface 147. Examples of excursion plan criteria according to one embodiment of the invention include an excursion package total cost. Other examples of excursion plan criteria include excursion dates, duration, time. Further examples of excursion plan criteria include radius about a geographic location specified by user 199. Another example of excursion plan criteria comprises a number of participants in an excursion, and whether the participants are adults or children. According to embodiments of the invention, excursion criteria comprise any criteria provided by user 199 which are used by package generator 119 to generate an excursion package.

### Different Selection 215

Returning now to FIG. 2 device 100 selects a second excursion package. In one embodiment of the invention, device 100 enables user 199 to again cause device 100 to select a first excursion package from the excursion packages generated by package generator 150. For example, user 199 may decline the first package selected by device 100, and initiate device selection of a second package by again shaking, or otherwise moving, device 100. In that case, device 100 selects a second package and displays information about the second package, for example, as illustrated in FIG. 12.

In this manner, device 100 provides customization of packages while, at the same time, providing an element of surprise in excursion package selection.

In one embodiment of the invention, user interface of device 100 provides an interactive icon, for example icon 1111 of FIG. 11 (labeled ‘shake to select’). This icon enables user 199 to cause device 100 to select a random one of the packages generated by package generator 150. In other words, device 100 selects one of the packages for the user in response to the user moving the device. In that case, the device-selected package is displayed to user 199, for example as illustrated in FIG. 12.

At 205, package generator 119 determines when user 199 has entered each of the user's desired excursion components. In that manner, device 100 enables user 199 to generate packages having at least one excursion component, according to the user's desires. For example, user 199 is enabled to generate excursion packages having only a dining component. Alternatively, user 199 is enabled to generate excursion packages having both a dining and lodging components. Any combination of excursion components is selectable by user 199 and receivable by package generator 119.

### FIG. 3 Flowchart—Package Generation

FIG. 3 illustrates steps of a method for generating excursion packages according to an embodiment of the invention. For ease of discussion the steps of the method of FIG. 3 will be discussed with reference to the block diagram of device 100 illustrated in FIG. 1. At 303, an indication of a first component comprising an excursion to a desired destination is received. For example, user 199 operates input device 109 of user interface 147 to provide an indication that an excursion will include a lodging component. At 305, device 100 determines if further components will comprise an excursion. Device 100 receives each component indication until the last component has been indicated. At 307, component storage is provided. For example a database is populated with component data items. In one embodiment of the invention components are stored in a database 309, for example, in accordance with a data organization such as that indicated in FIG. 14.

At 311 at least one plan criterion is received. Examples of plan criteria are illustrated in FIG. 10. At 315, device 100 receives each plan criterion as it is selected by user 199. At 319 component objects are received. For example, for a given excursion destination, an excursion including a lodging component will comprise lodging objects, such as hotels associated with the destination. The received lodging objects are stored in a database at 321, for example in database 323 in accordance with a data organization such as that indicated in FIG. 14.

At 325 object attributes are determined. The object attributes are stored, for example in a database 326 in accordance with a data organization such as that indicated in FIG. 14. At 327, device 100, under control of a processor (not shown) generates packages by associating at least one object with each component of an excursion. According to some embodiments of the invention, device 100 associates objects with components in accordance with criteria received at 311.

At 329, a package ID is assigned to each package generated at 327. At 331 the package information is stored. In one embodiment of the invention, a package ID corresponding to each package is stored to comprise a portion of a look up table for later retrieval of stored package information. Steps 327 through 335 are repeated until packages comprising all possible combinations of objects and components meeting the excursion criteria are generated. At 337 the list of excursion packages is displayed. FIG. 11 illustrates an example of a device 100 including a display of excursion packages.

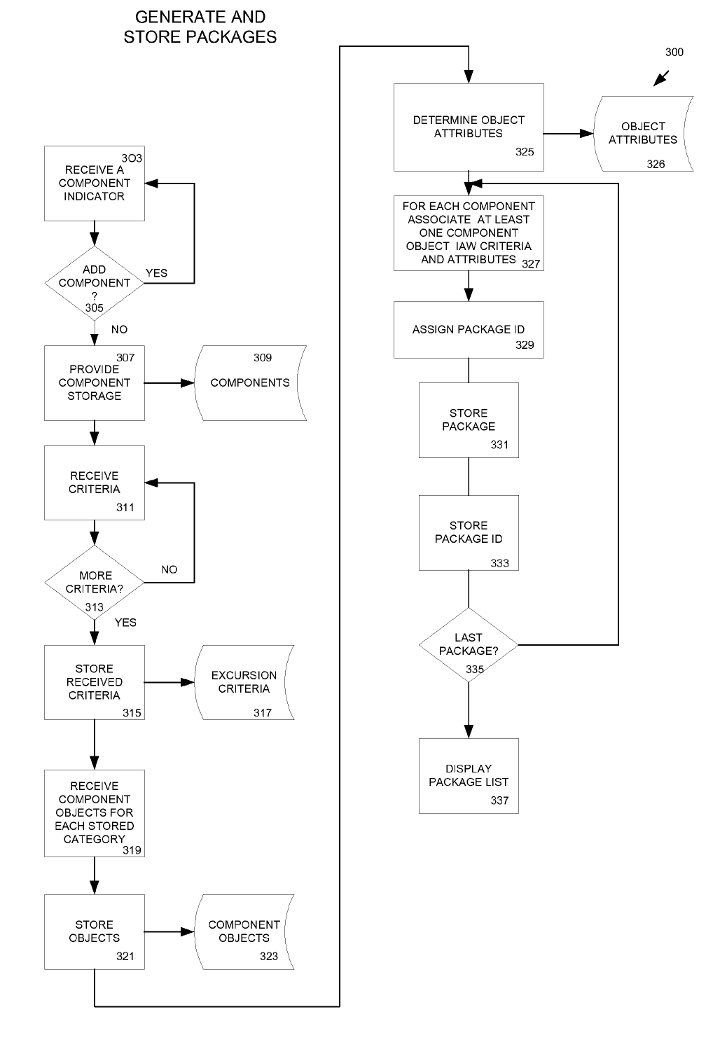

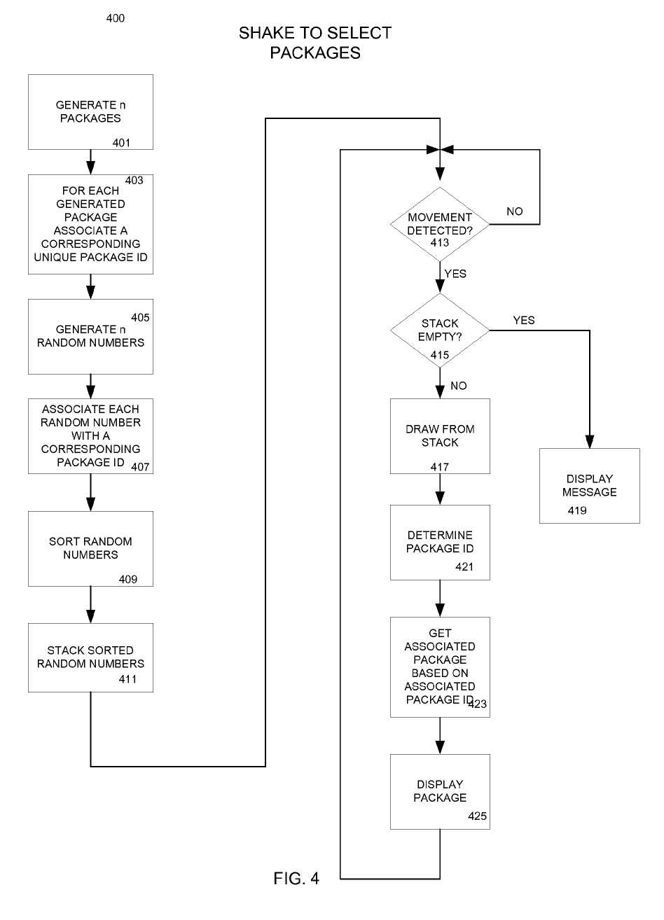

### FIG. 4 Random Selection

According to some embodiments of the invention, device 100 enables a user 199 to operate device 100 such that device 100 automatically selects one of the packages generated by package generator 150. In that case, the device-selected package is not known to user 199 in advance. In that manner, a user need not choose from among a plurality of generated packages appearing in a package list. Since each generated package meets the user's criteria for an excursion, the user can enjoy the surprise of having a suitable package selected by the device.

For example, embodiments of the invention are configured such that shaking device 100 will cause device 100 to select a package without user intervention. FIG. 4 is a flowchart illustrating steps of a method for random selection of an excursion package from a plurality of excursion packages generated by an excursion package generator of the invention, such as the excursion package generator depicted in FIG. 1 at 150.

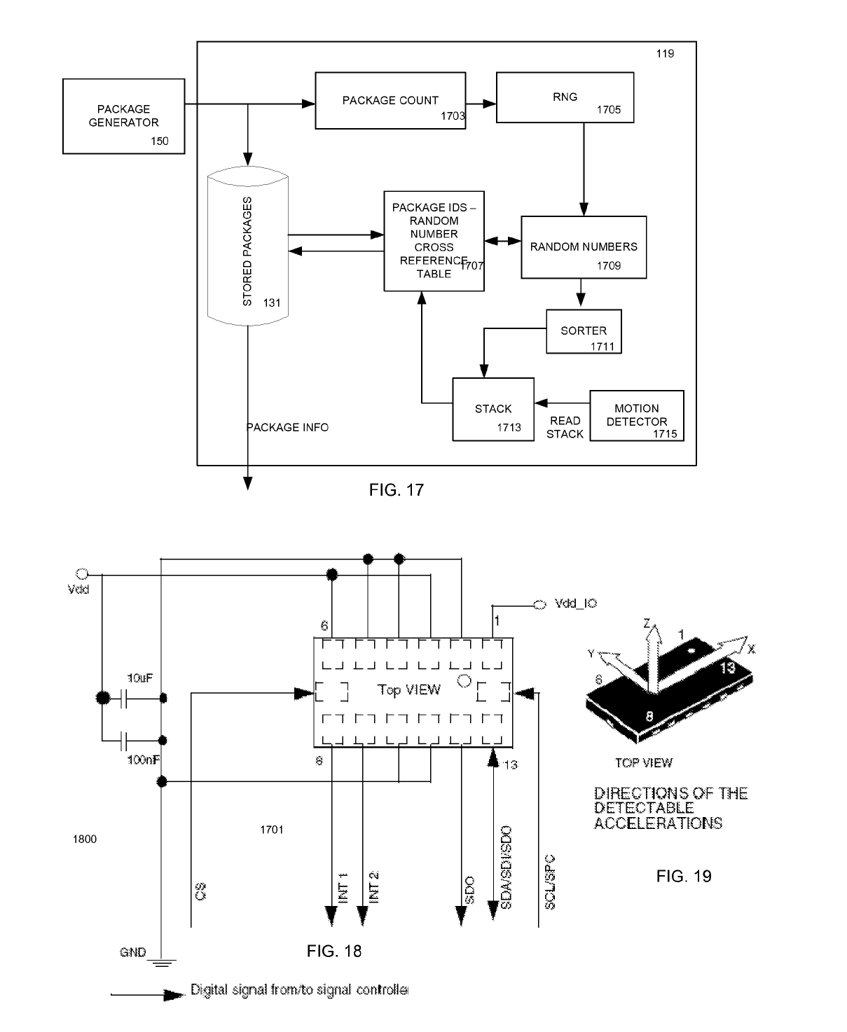

At 401 excursion package generator 150 generates a plurality, for example, n, excursion packages. For each generated package a unique corresponding excursion package ID is provided at 403. At 405 a random number generator such as RNG 1705 (illustrated in FIG. 17) generates n random numbers. At 407 a look up table, for example, look up table 1707 (illustrated in FIG. 17) cross references each unique package ID to a corresponding one of the n random numbers provided by the random number generator.

At 409 the random numbers are sorted. For example, in one embodiment of the invention random numbers are sorted in ascending numerical order. Other embodiments of the invention sort the random numbers in descending numerical order. A wide variety of sorting algorithms will be suitable for performing sorting step 409. Sorting of the random numbers results in a corresponding sort of associated package IDs. Therefore, any sorting order of the randomly generated numbers will result in a randomly sorted list of package IDs.

At 411, the sorted random numbers are stacked. Examples of suitable stacking methods include first-in-first-out (FIFO) stacking, last-in-first-out (LIFO) stacking, as well as a variety of other stacking techniques. In one embodiment of the invention, once a package has been selected, subsequent package selection will not result in a selection of a previously selected package. In that embodiment, any stacking technique that stacks n sorted random numbers such that a draw from the stack is not replaced is suitable to implement embodiments of the invention.

In another embodiment of the invention a previously selected package may appear in subsequent package selections. In that embodiment, any stacking technique that stacks n sorted random numbers such that a draw from the stack is replaced is suitable to implement embodiments of the invention.

At 413 device 100 waits until movement of device 100 is detected. At 415, device 100 determines if the stack is empty. If the stack is empty, for example, if all packages in the stack have previously been selected, a message is displayed on a display of device 100. For example, a message informing user 199 that all packages have been viewed is displayed. If the stack is not empty, a number is read from the stack, for example, from the top of the stack, as indicated at 417. At 417, in the case that device 100 detects movement a motion detector (for example detector 1715 of FIG. 17) provides a signal to stack 1713 to draw one of the randomly generated numbers from the stack.

At 421 the package ID associated with the number drawn in step 417 is determined. For example, in one embodiment of the invention a cross reference table such as look up table 1707 of FIG. 17 determines the package id corresponding to the number read from stack 1713.

At 423, the package associated with the package ID determined at 421 is retrieved from memory. In one embodiment of the invention, step 423 is accomplished by providing the package ID to a package information storage device 131. The information associated with the package ID is then retrieved from storage device 131 based on the package ID. At 425 the package information is displayed on a display device such as device 1200 (illustrated in FIG. 12).

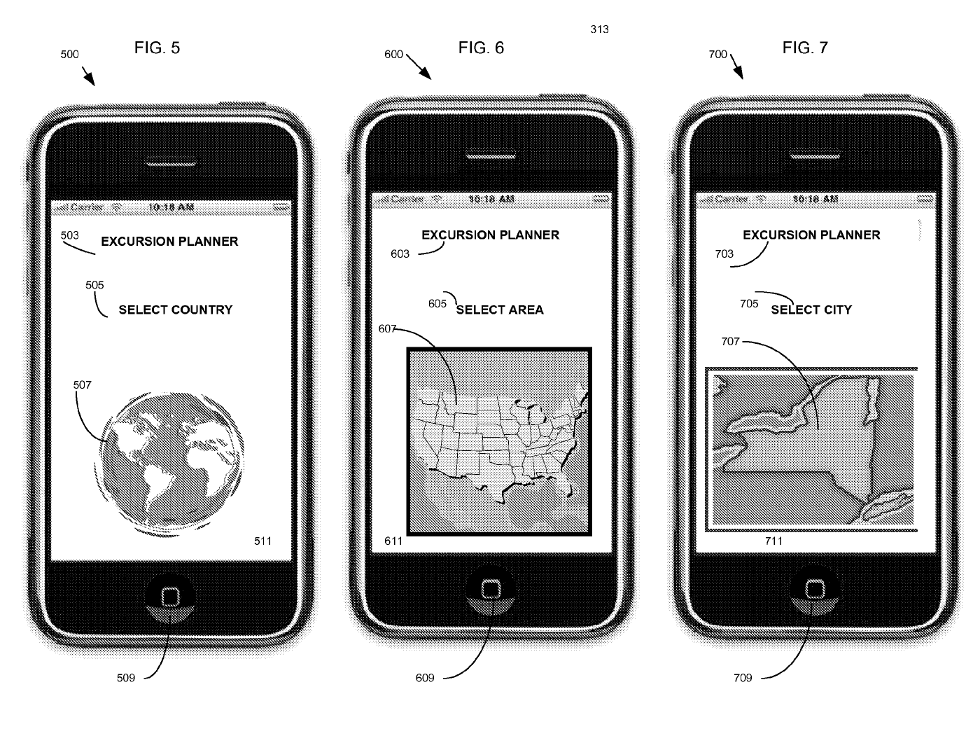

### FIGS. 5-7 Destination Selection

FIG. 5 is a pictorial diagram illustrating an excursion planning device according to an embodiment of the invention. According to this embodiment device 100 displays an interactive map to a user, e.g., user 199 of FIG. 1. Device 100 enables the user to select a geographic destination using the interactive map. In the example of FIG. 5 a map of the world is displayed. Device 100 receives an indication of a geographic region of the world to comprise a destination for an excursion. In one embodiment of the invention, display 511 of device 500 is a touch screen display and interactive map 507 is responsive to user touch of displayed world regions. However, the invention is not limited to any specific means of indicating geographic destination. Other geographic destination indications comprise, for example, “clicks” made by user 199 by placing indicia such as a cursor on a geographic region of map 507 and selecting the region using a mouse, cursor or other selector device.

FIG. 6 illustrates an example of destination selection wherein a user has selected the United States from map 507 of FIG. 5. FIG. 6 provides an interactive map 607 of the United States from which the user is enabled to select a more specific destination for an excursion. FIG. 7 illustrates an example of destination selection wherein a user has selected New York State from map 607 of FIG. 6. In the embodiment illustrated in FIG. 7, further specification of destination is enabled. For example, a user is enabled to select a city within New York State to which the user desires to plan an excursion.

### FIG. 8 Destination Indication

FIG. 8 is a pictorial diagram illustrating an excursion planning device according to an alternative embodiment of the invention. In the embodiment depicted in FIG. 8, device 100 generates excursions in response to user 199 directly providing an indication of a desired excursion destination. Device 100 receives the destination indication from user 199 via graphical user interface 811. For example, user 199 selects a city, for example, New York City as a destination. In that case user 199 indicates the destination by entering a city name, zip code, latitude longitude, county name, or other destination indication, using a keypad, touch-screen or other selecting device associated with device 100.

### FIG. 14 Data Dictionary

FIG. 14 depicts an example data dictionary suitable for use in various embodiments of the invention. In this embodiment of the invention an excursion package is defined by package components. Each package component comprises at least one object. Each object is characterized by object attributes. For ease of discussion, only two excursion components, ‘lodging’, and ‘food’ are depicted in FIG. 14. However, those of ordinary skill in the art, upon reading this specification, will appreciate that other excursion components may comprise data dictionary 14. Further, the invention is not limited to any particular data hierarchy or data definition. As long as excursion components are able to be associated with an excursion, and component objects associated with components, any data structure is suitable for use in the various embodiments of the invention.

In the example of FIG. 14 data for excursion package generation is organized at the highest organizational level by an excursion destination. In this example, device 100 has received a destination indicator corresponding to Atlanta, Georgia. At the next level of data organization are excursion components. A first example component of an excursion to Atlanta Georgia comprises lodging. A second component of an excursion to Atlanta, Georgia comprises Food.

At the next level of data organization, objects are associated with excursion components. For example, for first component ‘lodging’ in Atlanta, Georgia, a first object comprises ‘Hilton Hotel’. A second object comprises ‘Holiday Inn’. Each object is characterized by attributes. An example attribute of ‘Hilton Hotel’ is cost of one night stay. Another example attribute of the object ‘Hilton Hotel’ is the quality of the object, for example, number of stars in a rating system. By associating attributes with objects, device 100 enables a user to specify criteria for an excursion. For example, a user specifies a total cost for an excursion. In that case, the attribute cost for Hilton Hotel is used by device 100 in determining a total cost for an excursion package including Hilton Hotel as a lodging component.

Likewise, a second component ‘Food’ includes food objects. For example, a first food object comprises ‘Waffle House’. A second food object comprises “Pier One Lobster House”. Example attributes of food objects include first attribute cost and second attribute, cuisine type. It will be understood that the components, objects and attributes illustrated in FIG. 14 represent but a few of a wide variety of possibilities. The invention is not intended to be limited to the specific components, objects and attributes illustrated in FIG. 14. Rather, these examples serve to illustrated a data organization for such components, objects and attributes.

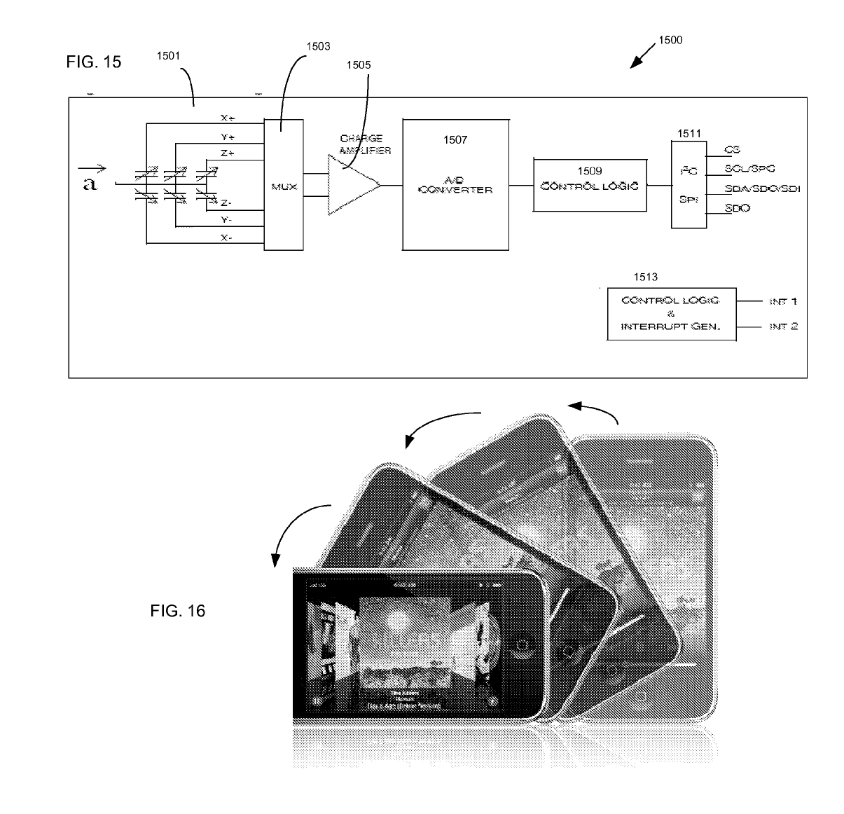

### FIG. 15 Accelerometer Block Diagram

FIG. 15 is a block diagram of a motion detector 1500 suitable for use in implementing various embodiments of the invention. The example motion detector 1500 illustrated in FIG. 15 comprises an accelerometer. In one embodiment of the invention device 100 is embodied in iPhone™. The iPhone™ accelerometer responds to motion using its built-in accelerometer. For example, when the iPhone™ is rotated from portrait to landscape, the accelerometer detects the movement and changes the display accordingly. Therefore, in one embodiment of the invention, when the accelerometer senses rotation of the iPhone™, the signal produced is utilized to select an excursion package from a list of excursion packages. A more detailed description of this feature is provided herein below.

The invention is also suitable for embodiment in other cellular devices. For example, the BalckBerry™ Storm device includes an accelerometer that senses the orientation and acceleration of the device. When the device is moved, the accelerometer senses the movement in 3-D space along the x, y and z axes. In that embodiment of the invention, the accelerometer provides an indication of sensed movement to package stack 133 in order to select a package for display to user 199.

### FIG. 16—Device Tilt Example

FIG. 16 is a pictorial diagram illustrating movement of an excursion planning device according to an embodiment of the invention. In the example shown in FIG. 16 the movement is a tilting movement. However, other movements are suitable for initiating a package selection. Any movement of device 100 which is detectable by the motion detector of device 100 is suitable for initiating package selection.

### FIG. 17 Block Diagram—Package Selector

FIG. 17 provides a physical and functional description of the package generator 150, illustrated in FIG. 1.

FIG. 17 is a block diagram of a package selector 119 according to an embodiment of the invention. Package selector 119 receives package information for each package generated by package generator 150. Each package generated by package generator 150 is associated with a corresponding unique package identifier. A cross reference table 1707 maps random numbers to their corresponding package ID.

A package counter 1703 counts the packages provided by package generator 150 to package selector 119. According to FIG. 17 the number of packages is denoted ‘n’. A random number generator (RNG) 1705 generates ‘n’ random numbers. The random numbers are stored in a random number storage 1709. Each random number is associated with a corresponding package ID. A sorter 1711 sorts the random numbers in random number store 1709.

The sorted random numbers are stacked in a stack 1713. Examples of suitable arrangements for stack 1713 include first in first out FIFO stacks, Last in first out LIFO stacks, and other stack arrangements. When device 100 detects motion, motion detector 1715 provides a signal to stack 1713. The signal causes a number to be read from stack 1713. Cross reference table 1707 determines the package id corresponding to the number read from stack 1713. The package ID is provided to package information storage 131. The information associated with the package ID is then provided to be displayed to user 199.

### FIG. 18—Configuring Accelerometer

FIG. 18 is a top plan view of an accelerometer 1800 suitable for use in various embodiments of the invention. FIG. 17 illustrates signal inputs and outputs for accelerometer 1800. In one embodiment of the invention a device, e.g., a Blackberry device is configured to sense device motion using an integrated accelerometer. One method for configuring device 100 to sense motion is to employ the Java Development Environment (JDE) to turn on the device's accelerometer sensor. In that case, invoking the ‘openRawDataChannel(Application)’ or ‘openOrientationDataChannel(Application)’ methods are suitable for turning on the accelerometer. In this case, while the returned channel is open, the accelerometer sensor is powered and is sampled for changes. When a change is sensed, an indication of a sensed change causes device 100 to read a number from package stack 133.

### Code Sample 1

The following code sample illustrates a method for retrieving periodic acceleration data in a dedicated thread according to one embodiment of the invention.

```
  public void run( )
  {
  // open channel
  Channel rawDataChannel = AccelerometerSensor.openRawDataChannel(
Application.getApplication( ) );
  // create raw sample vector with three components - X, Y, Z
  short[ ] xyz = new short[ 3 ];
  while( running ) {
  // read acceleration
  rawDataChannel.getLastAccelerationData( xyz );
  // process the acceleration
  process( xyz );
  // sleep for maintaining query rate
  Thread.sleep( 500 );
  }
  // close the channel to stop sensor query routine
  rawDataChannel.close( );
  }
```

### Code Sample 2

Another embodiment of the invention employs device orientation values instead of raw sample values. In that case, device 100 is configured to receive orientation change notifications using a listener. This approach avoids having to create another applications thread for periodic orientation checks. The following code sample illustrates how to use an orientation listener.

```
  private Channel orientationChannel;
  public void register( )
  {
  // open channel
  orientationChannel = AccelerometerSensor.openOrientationDataChannel(
Application.getApplication( ) );
  orientationChannel.setAccelerometerListener( this );
  }
  public void onData( AccelerometerData accData )
  {
  // get the new orientation
  int newOrientation = accData.getOrientation( );
  // relayout accordingly
  relayout( newOrientation );
  }
  public void unregister( )
  {
  // close the channel to save power
  orientationChannel.close( );
  }
```

In that case, when a new orientation is obtained device 100 reads from package stack 133.

### Code Sample 3

The following code sample illustrates how to specify background raw data listening.

```
  // create channel config
  AccelerometerChannelConfig channelConfig = new
AccelerometerChannelConfig( AccelerometerChannelConfig.TYPE_RAW );
  // specify background mode support
  channelConfig.setBackgroundMode( true );
  // open accelerometer channel that is active in background
  Channel channel = AccelerometerSensor.openChannel(
Application.getApplication( ), channelConfig );
```

### Code Sample 4

The following code sample illustrates how to configure channel to accumulate samples in a buffer.

```
  // create channel config
  AccelerometerChannelConfig channelConfig = new
AccelerometerChannelConfig( AccelerometerChannelConfig.TYPE_RAW );
  // specify number of raw acceleration samples to keep in buffer
  channelConfig.setSamplesCount( 500 );
```

TABLE 1

| | |
|---|---|
| AccelerometerSensor.Channel | Encapsulates an active |
| | connection to |
| | accelerometer sensor |
| G_FORCE_VALUE | Constant for raw |
| | acceleration value that |
| | is equal to G-Force. |
| ORIENTATION_BACK_UP | Orientation constant |
| | indicating the |
| | BlackBerry device |
| | display is directly |
| | facing the ground. |
| ORIENTATION_BOTTOM_UP | Orientation constant |
| | indicating the |
| | bottom side of the |
| | Blackberry device is |
| | moving upwards. |
| ORIENTATION_FRONT_UP | Orientation constant |
| | indicating the |
| | BlackBerry device |
| | display is facing 180 |
| | degrees from the ground. |
| ORIENTATION_LEFT_UP | Orientation constant |
| | indicating the left |
| | side of the BlackBerry |
| | device is moving upwards. |
| ORIENTATION_RIGHT_UP | Orientation constant |
| | indicating the right |
| | side of the BlackBerry |
| | device is moving upwards. |
| ORIENTATION_TOP_UP | Orientation constant |
| | indicating the top |
| | side of the Blackberry |
| | device is moving upwards. |
| ORIENTATION_UNKNOWN | Orientation constant |
| | indicating an unknown |
| | BlackBerry device |
| | orientation. |
| AccelerometerSensor.Channel | Turns on accelerometer |
| openChannel(Application app, | sensor based on |
| AccelerometerChannelConfig cfg) | channel configuration. |
| AccelerometerSensor.Channel | Turns on accelerometer |
| openOrientationDataChannel(Application | sensor for orientation |
| app) | data. |
| AccelerometerSensor.Channel | Turns on accelerometer |
| openRawDataChannel(Application app) | sensor for raw acceleration |
| | data. |

FIG. 19—Acceleration—Direction of Motion

FIG. 19 illustrates movement, e.g., acceleration of device 100 along x, y and z axes. There are two types of accelerometer data. Orientation, which represents handheld orientation with respect to the ground, for example, ORIENTATION_TOP_UP or ORIENTATION_LEFT_UP.

Raw acceleration samples, which are vectors of three coordinates: X, Y, and Z. Each raw value represents acceleration along X, Y and Z axes, as shown in the illustration of FIG. 18. Acceleration sensors return G-force values along the X, Y, and Z axes, relative to the ground, as follows. X axis runs from east (negative values) to west (positive values); Y axis runs from north (negative values) to south (positive values); and Z axis runs from the front of the BlackBerry device (negative values) to the back of the device (positive values).

For example, if the handheld is lying flat on a table, the X and Y values are equal to 0, while Z is equal to 1000 (which represents G-Force, or 9.80665 m/sec2). In freefall, all three values are equal to 0. The G-Force value is specified by G_FORCE_VALUE constant.

While the invention has been shown and described with respect to particular embodiments, it is not thus limited. Numerous modifications, changes and enhancements will now be apparent to the reader.

I claim:

1. An automated excursion planning device comprising:
an excursion package generator coupled to a user input device to receive excursion criteria from a user, said excursion package generator providing information comprising excursion packages based on said excursion criteria;
a memory configured for communication with said excursion package generator to receive and store said information related to said plurality of excursion packages;
a motion sensor configured for communication with said memory such that a first one of said plurality of excursion packages is displayed to said user in response to said motion sensor sensing a first movement of said excursion planning device.

2. The automated excursion planning device of claim 1 wherein said motion sensor communicates with said memory such that a second one of said plurality of excursion packages is displayed to said user in response to said motion sensor sensing a second motion of said excursion planning device.

3. The automated excursion planning device of claim 1 wherein said excursion criteria includes geographic information, said device further comprising:
a global positioning system (GPS) unit configured for communication with said excursion package generator to receive said geographic information from said user input device, said GPS unit providing information related to said geographic destination for each of said plurality of excursion packages in response to receiving said geographic destination information.

4. The automated excursion planning device of claim 1 further comprising:
a stack of excursion package identifiers, each identifier in the stack associated with a corresponding excursion package;
said stack coupled to said motion detector to receive a selection signal, said stack selecting an identifier from said stack in response to receiving said selection signal, wherein said corresponding excursion package is displayed to said user in response to receiving said selection signal.

5. The automated excursion planning device of claim 1 wherein said motion sensing device comprises an accelerometer.

6. The automated excursion planning device of claim 1 wherein said motion sensing device is selected from the group comprising: cellular telephone devices, personal digital assistants, mini-laptop devices.

7. A method for planning an excursion comprising:
receiving excursion package criteria from a user;
generating a plurality of excursion packages based on said excursion criteria;
storing said plurality of excursion packages;
sensing a first motion of a motion sensing device;
selecting using said motion sensing device, a first one of said plurality of stored excursion packages from said memory in response to said sensing said first motion;
displaying said first one of said stored excursion packages to a user.

8. The automated excursion planning method of claim 7 further including:
sensing a second motion of said motion sensing device;
selecting using said motion sensing device, a second one of said plurality of stored excursion packages from said memory in response to said sensing said second motion;
displaying said second one of said plurality of stored excursion packages from said memory in response to said sensing said second motion.

9. The automated excursion planning method of claim 8 wherein said step of sensing said first motion of said motion sensing device comprises sensing acceleration of said motion sensing device.
